(19) United States
(12) Patent Application Publication
(10) Pub. No.: US 2011/0175704 A1
(43) Pub. Date: Jul. 21, 2011

(54) Two-Person Linking Biometric Identification Device and Methods of Use Thereof

(76) Inventors: David A. Tesini, Hopkinton, MA (US); Joshua Wiesman, Boston, MA (US)

(21) Appl. No.: 12/917,030

(22) Filed: Nov. 1, 2010

Related U.S. Application Data
(63) Continuation of application No. PCT/US09/42484, filed on May 1, 2009.
(60) Provisional application No. 61/049,492, filed on May 1, 2008.
(60) Provisional application No. 61/095,373, filed on Sep. 9, 2008.

(51) Int. Cl. G06F 7/04

(52) U.S. Cl. 340/5.83; 340/5.82

(57) ABSTRACT

A biometric identification device (100) for two-person (for example parent and child such as a newborn infant) identification and matching. The device is adapted to provide a system for obtaining unique biometric identifiers from a parent and a child, which will remain linked through the life of the device. For example, the device (700) may be an integral device that includes a first portion (104) adapted for collection of an oral swab comprising epithelial cells and saliva (typically collected from a newborn infant), a second portion (102) adapted for collection of a biometric sample from another person (typically the new mother, either just before or just after birth), and a portion (103) connecting the first portion (104) and second portion (102). Also provided are methods for use of the provided biometric device for obtaining identification samples as well as methods of use of the provided device for identification of a person and/or identification of a parent/child match.

### CROSS REFERENCE TO RELATED APPLICATION

This application is a continuation of PCT/US09/42484 titled “Two-Person Linking Biometric Identification Device and Methods of Use Thereof” filed on May 1, 2009, which itself claimed priority of the following two provisional patent applications: 61/049,492 filed on May 1, 2008 and 61/095,373 filed on Sep. 9, 2008. The disclosures of all of these prior applications are incorporated herein by reference.

### FIELD OF THE INVENTION

The present invention relates to a biometric identification tool, in particular, a biometric identification device for parent and infant identification and matching.

### BACKGROUND OF THE INVENTION

Misidentification of newborn infants, whether intentional or inadvertent, is a source of great concern, both for medical care providers as well as effected families. Several methods of infant identification have been developed. Identification bracelets and radio frequency identification tags, generally applied to the arm or leg of an infant as well as to a parent, are commonly used methods for infant tracking and identification. However, in practice, bracelets and tags often become dislodged or lost, thereby increasing chances for misidentification.

Another method of infant identification commonly used throughout healthcare facilities includes foot-printing infants at birth. The FBI continues to advocate and encourage foot-printing infants at birth, as it represents a reliable, expeditious and cost effective method for establishing personal identity. Additionally, the FBI has suggested including a fingerprint of the mother of a child on the infant's footprint document, since it links the infant to the mother. Obtaining effective footprints useful for identification purposes, however, can be difficult. In recent years, media and scientific journals have expressed the opinion that hospitals waste time and money by foot-printing newborns. For example, at least one study of 20 newborns from different nurseries using techniques known to provide maximum detail of prints reported that 89 percent of obtained prints were technically inadequate for identification, and only 1 percent of prints were found to provide sufficient detail for positive identification.

The Joint Commission on Accreditation of Hospitals (also known as “The Joint Commission” or JCAHO), the American Academy of Pediatric Dentistry (AAPD), and many other hospitals and organizations recognize the important role and necessity for effective infant-parent (e.g., infant-mother) identification programs. These organizations encourage practitioners and hospitals to implement practices that aid in the identification of infants and children. For example, hospitals worldwide have implemented infant security policies incorporating biometric identification tools.

JCAHO Standards also address the real concern that hospitals face with infant abduction, security, release to wrong families and infant-parent (e.g., infant-mother) identification. For example, between 1991 and 1995 there has been a 55% reduction in infant abductions from healthcare facilities; however, from 1983-1999 the National Center for Missing and Exploited Children (NCMEC) reported 104 abductions from healthcare facilities. Additionally, discharge of infants to the wrong family occurs in both urban and rural settings. The primary cause of discharge of infant(s) to the wrong family is improper identification of the infant and mother. Other cases include deliberate switching of name bands, which occur in, for example, paternity cases.

In fact, concerns such as these have led JCAHO to identify the number one 2008 National Patient Safety Goal as: Improve the accuracy of patient identification. Overall, there is general consensus that organizations must have formal policies and procedures in place for proper infant identification, and furthermore, that all hospital personnel should be competent in infant-parent (e.g., infant-mother) identification procedures. Use and implementation of effective tools and procedures for infant identification will assist in achieving these goals.

### SUMMARY OF THE INVENTION

The present invention provides a biometric identification device that is useful for child identification and parent and child matching (e.g., infant identification, parent and infant matching). The inventive device captures biometric (i.e., biological) information directly from a person. When used to collect such information from two people, the identification of those people are linked via the device. An embodiment of an inventive device is adapted to provide one end or portion suitable for collection of a biometric sample from one or both parents (e.g., a finger imprint of a parent (e.g., mother, father and/or guardian)), and another end or portion suitable for obtaining an oral swab from an infant comprising saliva and epithelial cells (e.g., cheek cells) containing DNA as well as unique scent. The portions containing samples provide in combination a system for obtaining unique identifiers from parent(s) and a child, which will remain together through the useful life of the device. Also provided in the invention are methods of use of a biometric device for obtaining identification samples from two or more persons, as well as methods of use of a biometric device for identification of a child (e.g., an infant) and/or identification of parent(s)/child (e.g., mother/infant) match.

This invention features a two-person biometric identification device comprising a first portion adapted for collection of an oral swab comprising epithelial cells and saliva, a second portion adapted for collection of a biometric sample from another person, and a neck portion connecting the first portion and second portion, wherein the device comprises non-scented, non-bioreactive, bioinert material. The oral swab may be collected from an infant and the biometric sample may comprise a fingerprint collected from an infant's parent. The fingerprint may be collected from the infant's birth mother.

The first portion may comprise ridges for facilitating collection of cells and saliva. The first portion may comprise one or more holes in the device for facilitating collection of a sample. The second portion may comprise a thermoplastic material. The device may further comprise a container. The container may comprise a removable cover for holding the device and positioning the second portion for collection of a fingerprint. The removable cover may comprise separate bottom and top cover portions for protecting the second portion sample collection area. The container may comprise a case which holds the device in place to retain integrity of collected sample.

The device may further comprise one or more markings on the device to assist in sample collection or sample storage. The may further comprise a sealable storage container, which may comprise a sealable plastic bag. The device may be formed from a thermoplastic material. The first portion may further comprise an absorbent material to assist in saliva sample collection.

The device may further comprise a digital memory device that stores information representative of the oral swab and the biometric sample. The stored information may include one or more of a DNA sequence, a representation of the scent of the saliva, and a digital scan of a fingerprint.

Also featured is a method of collecting samples for generating a biometric parent and infant identification and matching device comprising using a device such as described above for collection of an oral swab comprising epithelial cells and saliva from an infant and collection of at least a fingerprint impression from a parent, and storage of the device in a sealed storage container; wherein collection and storage of both samples links the parent and child, thereby providing a biometric parent and infant identification device. The parent sample may be collected from a mother at admission to a healthcare facility in advance of delivery of an infant, and the infant sample may be collected from the newborn infant within an hour of delivery. The parent sample may be collected from a guardian or non-biological parent and the infant sample may be collected as soon as the guardian or non-biological parent pair is confirmed.

Also featured is a method of identifying an unidentified child comprising obtaining a sample from a child and comparing the sample to a retained sample from a biometric identification device such as described above, wherein a positive match of the infant sample to the sample from the biometric identification device confirms identification of the child. Also featured is a method of identifying a parent-child match comprising obtaining a sample from a child and a potential parent, and comparing the samples to retained samples of an infant and parent from a biometric identification device such as described above, wherein a positive match of the infant and potential parent samples to the samples from the biometric identification device confirms a parent-child match.

### BRIEF DESCRIPTION OF THE DRAWINGS

Objects, features and advantages of the invention will occur to those skilled in the art from the following detailed description of certain preferred embodiments and the accompanying drawings, in which:

FIGS. 1A-1E are top, enlarged partial detail, side, isometric, and end views, respectively, of one embodiment of the invention comprising a biometric identification device.

FIGS. 2A-2F are top, side, one end, isometric, second end, and enlarged partial cross-sectional detail views, respectively of an embodiment of the invention comprising a bottom cover of a biometric identification device.

FIGS. 3A-3E are top, side, one end, isometric, and second end views, respectively of an embodiment of the invention comprising a top cover of a biometric identification device.

FIGS. 4A, 4B and 4C are perspective, top and partial enlarged views, respectively, of an embodiment of sealable storage container of the invention.

FIGS. 5A and 5B are end and top views, respectively, of an embodiment of a device that can capture a fingerprint from two people, which would typically be both parents.

FIG. 6 is a cross-sectional view of an embodiment of a container that can hold two of the devices, or one device and another identifier, in separate compartments.

FIG. 7 is a schematic diagram of an alternative embodiment of the inventive device that digitally stores information representing the saliva sample from one person and the biometric information from the other person.

### DESCRIPTION OF THE EMBODIMENTS

The Joint Commission (JCAHO) and many hospitals and organizations recognize the important role and necessity for effective infant-parent (e.g., infant-mother) identification programs. Hospitals worldwide have implemented infant security policies incorporating biometric identification tools. The present invention provides healthcare facilities and parents with improved means to collect, store, and save samples of uncontaminated DNA and saliva scent samples from infants. Additionally, provided devices and methods provide tools and methods for establishing a parent-child biometric link by recording parental biometric samples from one or more parents (e.g., fingerprint impressions) on a biometric device containing an infant sample.

The present invention features a biometric identification device. One end of a device is adapted to obtain a mouth swab from one person, typically, an infant (e.g., a newborn), and another end of a device is adapted to accommodate one or more biometric samples (e.g., fingerprint impressions) of one or more other persons, typically parents (e.g., a mother). Thus, provided is a device and a method for identifying an infant and a parent-child relationship (e.g., a mother-infant relationship). In particular, at least a dual end, hypoallergenic (i.e., bioinert), non-bioreactive, non-scented device comprising one end which can accommodate one or more fingerprints; and a second end which can be used to obtain a mouth swab from an infant is featured. Once both identification samples are obtained, a device will maintain a link between one or both parents (e.g., the mother, or a guardian) and infant in one, unique biometric tool to retain a record for infant identification and parental matching.

Provided devices are specifically designed to capture shedding epithelial cells (e.g., cheek epithelial cells) containing DNA. The adapted end of a device is designed to be swabbed inside an infant's mouth against the oral mucosa of a newborn in the first hours of life, for example, by a medical practitioner. Additionally, an end of the device is designed to capture an infant's unique scent of saliva. According to police canine officers, uncontaminated scent of human saliva is the scent article of choice for scent discriminating canines to track a missing child 4. An uncontaminated, unique scent allows police and scent discriminating canines to follow a very specific trail of a child.

Provided devices are also specifically designed to capture a biometric sample from one or more parental guardians (e.g., a parent fingerprint (e.g., a mother's thumbprint)). A pliable material capable of acceptance and retention of a detailed imprint of a fingerprint impression is preferred. For example, a thermoplastic material can be used which can accommodate a fingerprint impression (e.g., material can be heated and softened to allow for a parent's (e.g., a mother's) fingerprint (e.g., thumbprint)), and maintain the integrity of the impression over time.

A biometric sample from a parent may comprise any applicable, readily obtainable biometric sample, and may include, but is not limited to, one or more of a fingerprint impression (which may include cells from the finger), a hand impression (e.g., palm print, vein pattern impression or scan, hand geometry impression), a fingerprint scan, a face recognition scan, a retinal scan, a dental impression, a hair follicle, a blood sample, a saliva sample, a cheek/oral swab sample, etc. Regardless of the type of biometric sample collected, a portion of a device is adapted to facilitate sample collection directly onto/into a device, or alternatively, in an instance where direct sample collection in/on a device is not feasible, a portion of a device is adapted for containment and security of results of a collected sample (e.g., electronic memory to store results of a scan such as a fingerprint, retinal or facial scan) in order that the collected sample remains with a device until such a time that comparison is required for identification and/or matching purposes. Furthermore, depending on the type of biometric sample, once collected, certain sample(s) require containment to provide protection and/or prevention from sample alteration, loss, or contamination. Thus, adaptation of a provided device will be in accordance with collection as well as storage, safekeeping, and retention of collected sample, sufficiently relevant to the type of biometric sample to be obtained.

Still further, a biometric identification device according to the present invention may be adapted to include portions for sample collection from an infant as well as both parents, or even more sample collection portions (e.g., for a family). Thus, a device comprises at least two, and possibly more, portions adapted for sample collection. Regardless of the number of sample collection portions, a featured device is hypoallergenic (i.e., bioinert), non-bioreactive, and non-scented, comprising at least one portion which can accommodate a biometric sample from at least one parent or guardian and at least one portion which can be used to obtain a mouth swab from an infant. Once each desired identification sample is obtained, a device will maintain a link between two or more family members, including, but not limited to, at least a parent (e.g., the mother) and infant, in one unique biometric tool. Such a tool can then be retained to establish a record for identification purposes (e.g., child identification, infant and parental matching, familial identification and matching, etc.).

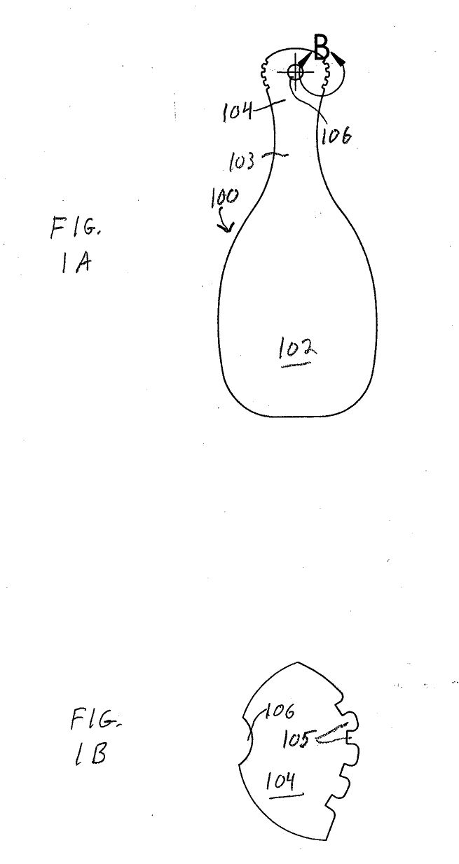

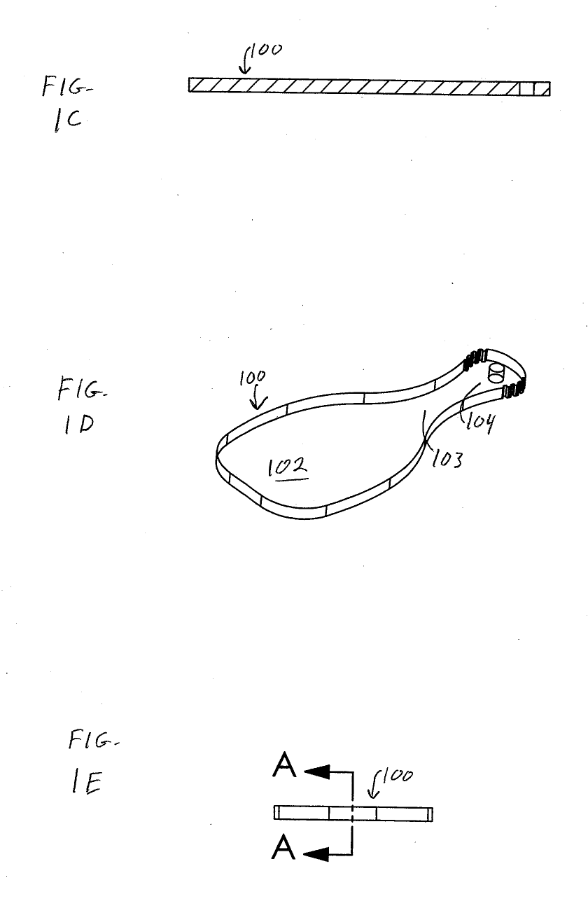

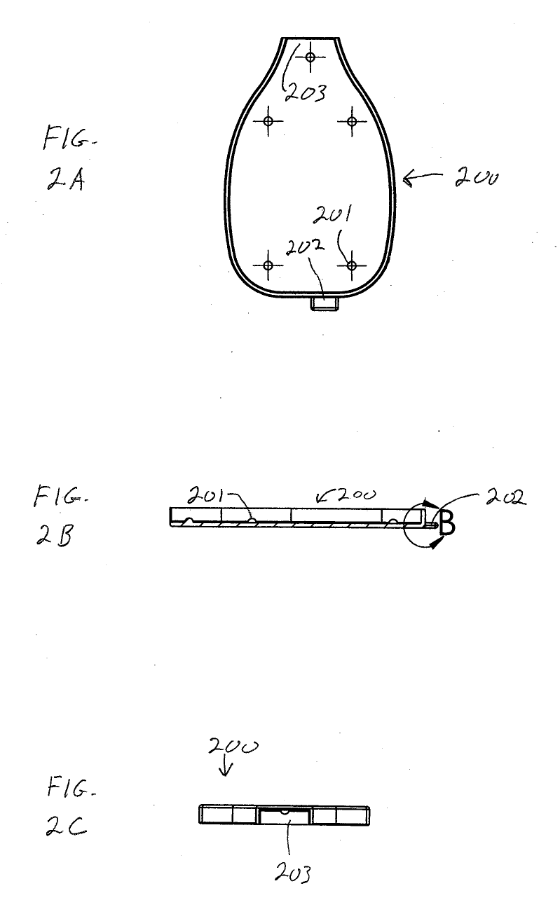

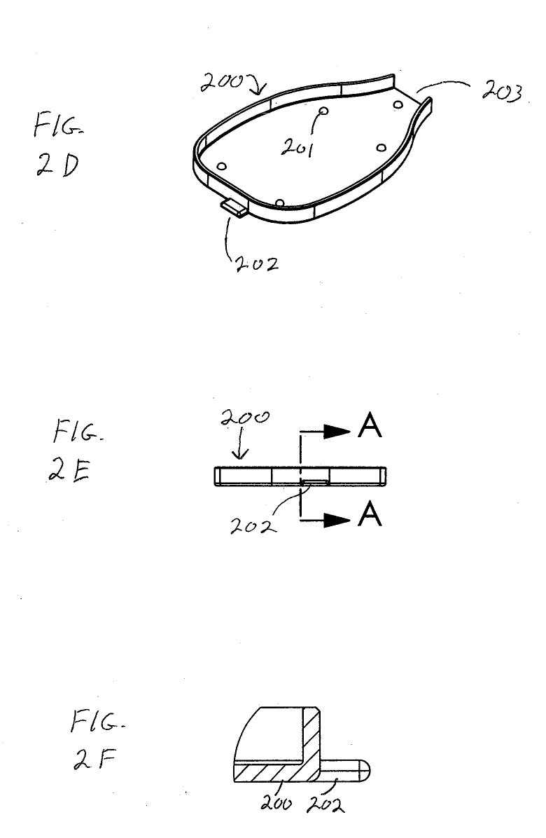

One embodiment of the invention is depicted in FIG. 1A-1E. Device 100 has a first portion 104 and second portion 102 that are adapted for sample collection, and a neck portion 103 that connects the first and second portion.

A typical device 100 of this shape has a thickness of about 0.125 inches, and is either flat or generally convex. In the embodiment shown in the drawings (which is exemplary and non-limiting of the invention), device 100 is a unitary molded member about 3.45″ long, about 1.52″ wide at its widest, about 0.67″ wide at narrow end 104, and about 0.39″ wide at its narrowest in portion 103. Each of the three teeth 105 created on each side of end 104 are about 0.05″ wide and 0.03″ high, and are spaced apart by about 0.03″. The ends of these teeth follow the nominal contour of the sides.

In certain embodiments, a device may further include an optional handle portion which may provide a convenient means for handling a device during sample collection. A handle portion may be incorporated into a device at any appropriate convenient location.

Additionally and/or alternatively, a device may further include an optional tag or markings on a device to facilitate sample collection and/or identification of a parent or infant. For example, one or more markings may depict location for placement of a device for sample collection. Additionally or alternatively, one or more markings may be included on a device to mark with parent and/or infant identification (e.g., a mother's name, an infant's name, birth date). In some embodiments, identification markings may be included on the back or side of a device so as to not interfere with sample collection.

In this embodiment, first portion 104 is adapted for collection of an oral swab sample. A series of structures 105, which may include protrusions and/or recesses which create openings between structures, is created in one or more areas along the edge of portion 104 of device 100, to create a series of lobes and pockets. In one embodiment, the ends of structures 105 remain within the contour of a device (e.g., are created by including recesses in a device). In certain embodiments protrusions may extend beyond the continuous contour of device 100 in the absence of structures 105 (e.g., are created by including lobes which extend beyond the nominal edge contour of the device). In yet another embodiment, structures may be slightly withdrawn from the continuous contour of device 100 in the absence of structures 105 (e.g., are created by including recesses and lobes which are embedded in the edge and do not extend to the contour of the device).

In still another embodiment, one or more through-holes or blind openings 106 (typically a hole through the device thickness, or a blind opening in one or both surfaces), are included in device 100, and are also adaptations to facilitate sample collection. Feature 106 may be in addition to, or instead of, structures 105.

Structures 105 and opening 106 are designed to capture epithelial cells and saliva located in the mouth. Structures 105 typically are rubbed against the inside of an infant's cheek, which can further loosen cells from the mucous membrane, and sample is then captured in the relevant features. Structures 105 may be any size, though should not feel sharp when a swab is taken. In the depicted embodiment, protrusions 105 are about 0.05 inches wide and protrude about 0.03 inches, and are spaced apart by about 0.03 inches.

Alternatives to structures 105 and openings created between structures, and opening 106 can be used. For example, roughened or dimpled areas (e.g., along the perimeter of a device where structures 105 and/or hole 106 are depicted in FIG. 1, and/or on the top or bottom of the device), or a series of small spaced protrusions (e.g., extending from the outer contour of a device) may be incorporated into a portion of a device that enters an infant's mouth, to capture saliva and cells. Additionally or alternatively, the top and/or bottom surface of device 100 may include bumps or protrusions and/or pockets or recessions that create spaces for capturing sample.

Another alternative or additional structure includes one or more small tubes or similar absorbent structures that capture saliva and/or cells by capillary action or absorption, and may be useful for storage of sample for longer periods of time than is the case when the captured biological material is exposed to the air. In a typical application, one style of such a feature is incorporated in a device, though two or more may be used if desired. Other possible shapes, styles and arrangements of feature(s) may be useful in the invention to facilitate sample collection, and any adaptation to the portion of a device adapted for obtaining a sample from an infant may be incorporated accordingly.

Further included in the embodiment depicted is a second portion 102 of device 100 adapted for collection of a fingerprint impression sample. As mentioned, device 100 may be flat or slightly convex in shape. Portion 102 should be of a convenient size and shape to obtain a fingerprint impression. For fingerprint collection, the material of portion 102 is important for sample collection and retention. In one embodiment, portion 102 is constructed of a thermoplastic material capable of recording an impression, then maintaining the impression for an extended period of time. In an embodiment, a thermoplastic material comprises a low temperature thermoplastic material, wherein the material can be heated to render the thermoplastic impressionable at a temperature that is tolerable for a parent for sample collection. In another embodiment, the material can present appropriate properties at room temperature, thus avoiding the need to heat the device before use.

In one embodiment, portion 102 is constructed of a thermoplastic material such as POLYFORM® low temperature thermoplastic material (Sammons Preston Rolyan Medical Products, Cedarburg, Wis.). For example, this material has virtually no dimensional change over the operating temperature range (room temperature to around 150° F.). As a result, an impressed device will accurately record a finger imprint, and can be used to reliably accomplish identification, should such be necessary. For sample collection, the thermoplastic material is heated to a point at which it can be impressed (typically at least about 150° F.). A finger is impressed into the material, and kept still for a time that is sufficient to allow the material to cool enough such that a device maintains a clear, detailed fingerprint impression.

In certain embodiments, a device may be made fully or partially from other suitably impressionable materials which are easily formable and generate high detail, such as wax or other thermoplastics. Material density must be sufficient such that it holds its shape after being deformed and does not creep (e.g., material deforms under its own weight) over time. Such materials can potentially present appropriate properties at room temperature, thus avoiding the need to heat the device before use taking the impression.

In some embodiments, the materials of a device are identical throughout construction. In some embodiments, the materials may vary (e.g., a first portion and second portion designed for separate sample collection may be of the same or of different materials).

In some embodiments, a multi-material design comprising varied materials may be utilized in order to achieve variable shape, incorporation of structures for facilitation of sample collection, and/or ease of use and/or storage, in order to achieve the desired results. For example, a first portion adapted for infant sample collection may comprise different material than all or a portion of a device so that a device has sufficient flexibility and stiffness to obtain an oral swab in the desired manner. In one embodiment, a portion adapted for infant sample collection may optionally include additional absorbent material to facilitate collection of saliva. Additional absorbent material (such as cotton gauze) may be attached to or incorporated into the portion of a device adapted for infant sample collection.

Additionally or alternatively, material utilized for a second portion adapted for obtaining a fingerprint impression may optionally be comprised of the same or a different material to facilitate readily obtaining an impression as well as retention of sample for an extended period of time. Furthermore, the neck of a device connecting the first and second sample collection portions may be constructed of the same material as one or both first and/or second portions; or it may be constructed of still a different material, and may have any shape or structure that appropriately connects the two working portions.

Preferably, any material used in devices are bioinert (e.g., do not illicit allergic response), and non-bioreactive. For example, materials must not leach or release any chemicals over time. Additionally, the material must not interfere with a sample comprising scent or DNA. In certain embodiments, material is medical grade.

For production of a device, desired material may formed by injection molding, die cutting or stamping, laser cutting, digital knife cutting or any other applicable method that does not produce unwanted rough edges, excessive flash or shavings (small remains after a cut).

Devices described herein may be adapted and altered using various sizes and shapes as well as arrangements of each end for obtaining identification samples. Preferably, sizes, shapes, and arrangements utilized are adapted for ease of obtaining sample(s), and storage purposes. As discussed above, the size, shape, and arrangement of a biometric infant identification device, as well as integration of one or more sample obtaining system(s), may be adapted accordingly to provide the appropriate configuration necessary for obtaining identification sample(s), and maintenance of samples in storage over time in order to retain sample integrity.

For example, a portion adapted for infant sample collection, may comprise a shape and form to facilitate collection of an oral swab sample, however, the size and shape should not be traumatic and should be sized to fit and be used accordingly in an infant's mouth under relaxed motions, (e.g., collection of a sample does not require stretching, straining, or forced movement). Additionally, a portion adapted for fingerprint impression collection should be of sufficient shape and size so as to capture at least one fingerprint. Which selected finger does not matter, however, the imprint preferably will capture at least eight identifiable features recognizable by fingerprint identification experts for optimal efficacy. It is recommended that the selected finger for imprinting be documented (e.g., indicated on a device tag or container) for identification purposes.

In another embodiment of the invention, a device includes a container. A container includes a package which may enclose part or all of a device, or may include a package which may enclose part or all of a portion of a device. A container may function to secure a device or portion of a device; to enclose all or a portion of a device; to serve as security, isolation or prevention of contamination of a portion of a device (whether before or after sample collection); to serve as a handle for use of a device; or any combination of one or more of the foregoing functions.

Depicted embodiments include a cover that encloses one sample collection portion. Alternatively, a container may enclose an entire device, or at least a portion of an entire device (e.g., the bottom of an entire device). Still further, a second container may be optionally included wherein a second sample collection portion may be separably enclosed, whether partially or entirely. In yet another embodiment, separable containment for each sample collection portion may be included, as well as yet an additional container which encloses a completed device containing samples.

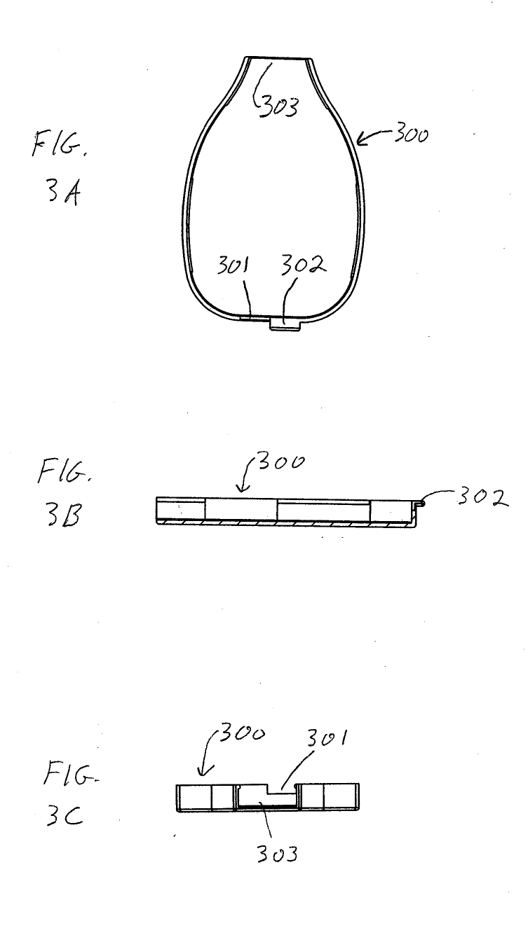

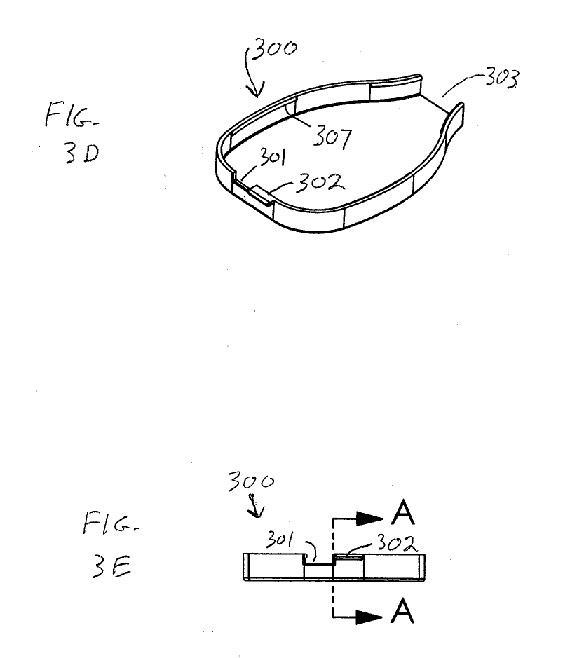

In some embodiments, a bottom cover is included which is useful for holding a device in place. Such an embodiment is depicted in FIG. 2A-2F. Bottom cover or tray 200 may comprise a shape to accommodate a portion of device 100 adapted for collection of a fingerprint. Cover 200 may include devices such as bump features 201 on a container bottom which comes into contact with device 100, preventing it from rattling or moving around. In certain embodiments, device 100 may freely move within bottom cover 200 until a fingerprint impression is obtained, which requires downward pressure on the device that deforms the device material around bumps 201 to fix device 100 in cover, inhibiting future movement.

When a bottom cover is designed to enclose only a portion for collection of a fingerprint, a space or gap in a peripheral region of a cover is included, such as is depicted by space 203 to accommodate a neck portion of device 100. A bottom cover may further include structure for attaching a bottom cover to a top cover. For example, depicted is a tab 202 to function as a snap in conjunction with a top cover 300, depicted in FIG. 3A-3E.

In the preferred embodiment shown in the drawings (which is exemplary and non-limiting of the invention), bottom cover 200 is about 2.43″ long, about 1.64″ wide at its widest, and defines an opening of about 0.47″ at its narrow end. The cover is molded or formed in plastic, and is about 0.04″ thick and about 0.175″ in height. Tab 202 is about 0.12″ long and about 0.26″ wide.

In some embodiments a top cover is further included. A top cover may be designed to fit with a bottom cover. A top cover may enclose all or a portion of a device which is covered by a bottom cover. Depicted in FIG. 3A-3E is top cover 300 which encompasses a portion of device 100 adapted for collection of a fingerprint. Similar to bottom cover 200, top cover 300 includes a space 303 to accommodate a neck portion of device 100. Additionally, top cover 200 includes a tab 302 and a space 301 to function as a snap in conjunction with bottom cover 200 via an interference fit with tabs 202.

In the preferred embodiment shown in the drawings (which is exemplary and non-limiting of the invention), top cover 300 is slightly larger than bottom cover 200 so it fits over the bottom cover to fully enclose end 102 after a fingerprint has been taken. Top cover 300 is about 2.47″ long, about 1.735″ wide at its widest, and defines an opening of about 0.56″ at its narrow end. The cover is molded or formed in plastic, and is about 0.04″ thick and is about 0.25″ in height so that it can fully encompass the bottom cover. Tab 302 is about 0.08″ long and about 0.29″ wide. Slot 301 receives tab 202 in an interference fit to help hold the two cover halves together. Also, the partial lip 307 protrudes slightly inward such that it lies underneath the edge of the bottom cover when the top cover is placed over the bottom cover.

Depicted in FIG. 2 and FIG. 3 is an example of a container which comprises a separable top cover and bottom cover, operably releasably coupled together using the described snap and lip. A container may include such a snap case version (as shown), or may optionally include a clam-shell case wherein top and bottom covers are connected with a living hinge. Alternative variations of a container may be utilized in conjunction with a device, although the function remains the same.

A container may be comprised of any suitable material, though a selected material must be bioinert and non-scented to prevent disruption of a fingerprint, DNA or scent sample. Container material should have good fracture resilience, as well as high fatigue and creep resistance because it should preferably accommodate flexing during opening/closing. Furthermore, container material also preferably has lubricious properties to allow for easier opening/closing. Preferably, container material should allow for injection molding or similar technology for production purposes. Additionally, preferred container material is of sufficient hardness and, where applicable, of high durometer designation such that it protects samples (e.g., a fingerprint impression) so not to deform the fingerprint impression following collection and/or during infant sample collection, and after collection as well as over time.

Exemplary container materials include, but are not limited to Delrin, ABS, polyethylene, nylons and silicones. In certain preferred embodiments, container material is medical grade. In certain embodiments, container material comprises a plastic (e.g., ABS plastic or equivalent, medical grade ABS or equivalent).

Another embodiment of the invention further includes use of a sealable storage container. A sealable storage container may be used in conjunction with a device in lieu of and/or in addition to one or more container(s) described above. A sealable storage container is preferably sterile and clean, with no holes or features allowing a device or sample to contact the outside world. Any method for sealably containing a device once samples are obtained is suitable.

In certain embodiments, a sealed storage container comprises a sealable plastic storage bag. A storage bag should be sealable, and could be a zip enclosure type plastic storage bag (e.g., a double zip plastic storage bag, a zip/adhesive fold over plastic storage bag), to prevent opening and limiting contamination of the contents.

In other embodiments, a sealable storage container may include any other sealable container (e.g., a plastic container) such as, for example, a box. An appropriate storage container should be sealable to air and to prevent opening and limiting contamination of the contents.

A sealable storage container may have an area or feature to hold additional items or identification of an infant or parent. For example, a sealable storage container may comprise an area to include, for example, infant/family name, infant's date of birth, parent information, and/or contact information. Preferably a storage container can be permanently marked with such information. Additionally, a storage container may accommodate additional items such as, a baby bracelet, a hospital tag, and/or a mother's identification tag.

A sealable storage container may further include a security seal on a container to prevent undesired entry and notification of entry after samples are collected and sealed. A security seal may confirm contents of sealed container have not been tampered with, and contents remain intact until obtaining samples for identification purposes is required.

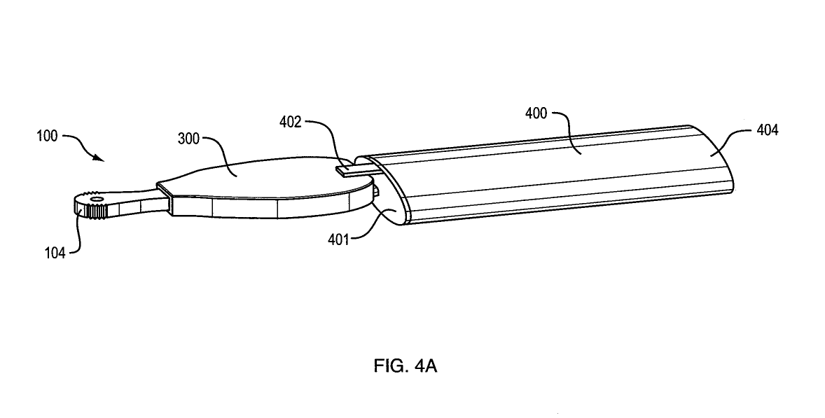

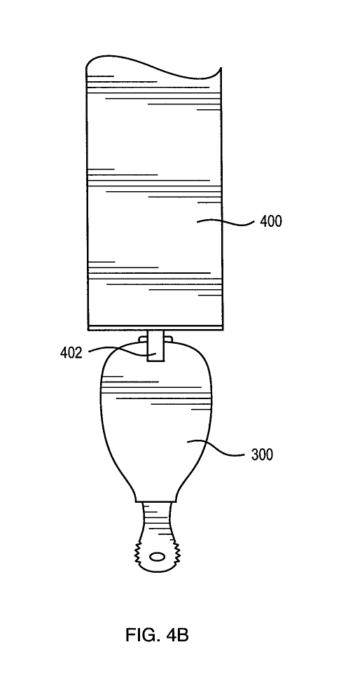

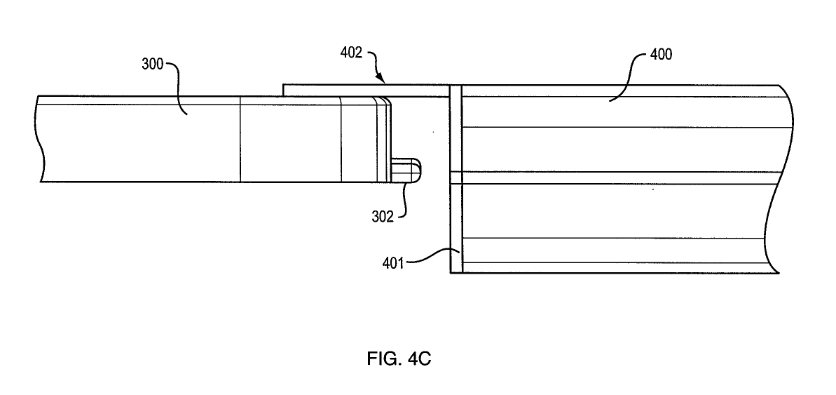

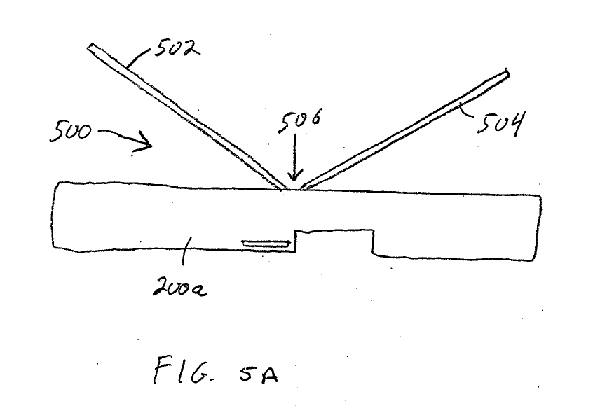

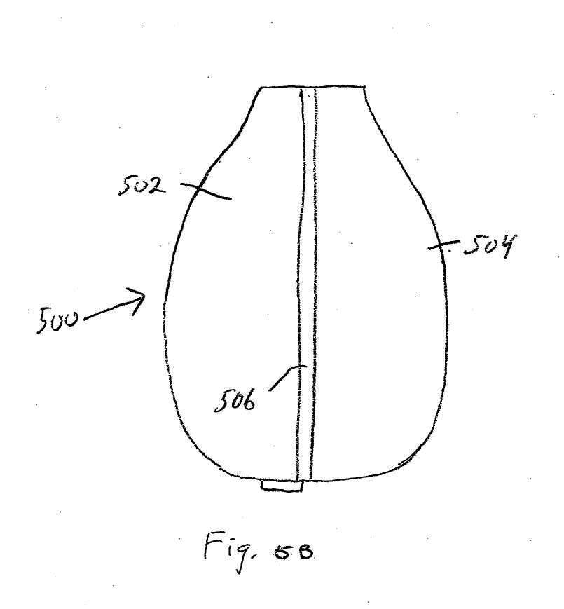

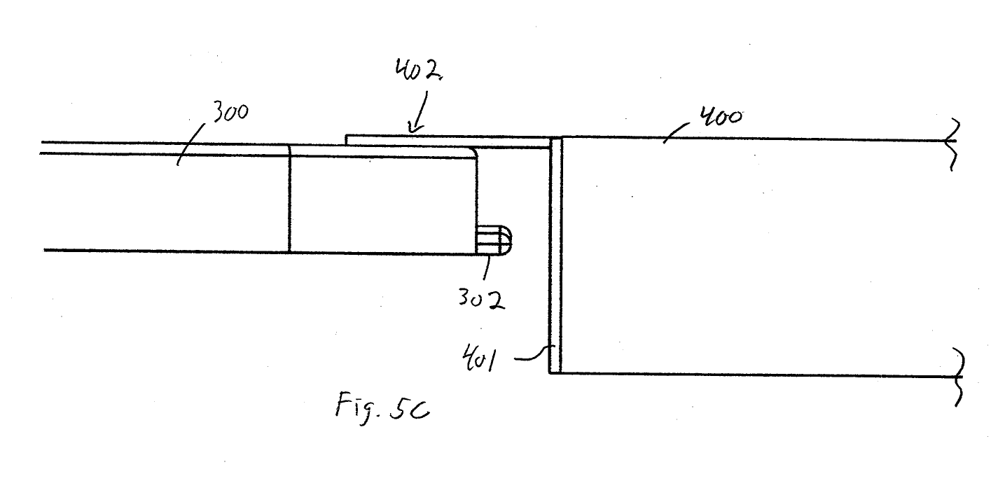

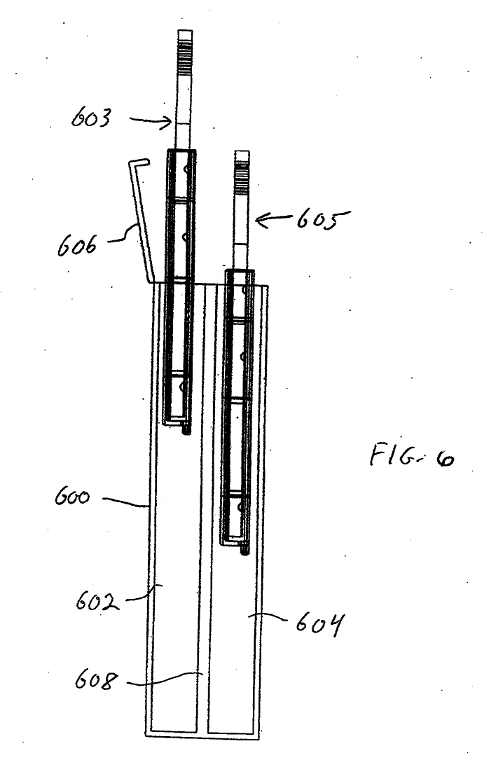

FIGS. 4A, 4B and 4C show an embodiment of sealable storage container 400 of the invention. Container 400 comprises a sealable flexible plastic storage bag that is closed at end 401 that is proximate to case 300, and open but closable at the other end (not shown). Bag 400 is attached to the case (either top cover 300 as shown in these drawings, or bottom cover 200, not shown in the drawings). Attachment in this embodiment is accomplished through heat sealing or adhesive attachment of band 402 to cover 300.

Bag 400 is preferably initially rolled up onto case 300, and is unrolled to the position shown in the drawings to allow access to the identifier. When case 300 is placed over the identifier after the sample(s) have been obtained, bag 400 is rolled back over the identifier and case such that open end 404 extends beyond end 104 of device 100. End 404 of bag 400 is sealable, for example with a zip-type enclosure and/or an adhesive flap seal, to protect the contents and limit contamination of the contents.

FIGS. 5A and 5B show an embodiment of a device that can capture a fingerprint from two people, which would typically be both parents. The device itself would be as described above, but the end that accepts fingerprints would be wide enough to capture two fingerprints, potentially about 4 inches wide. To help prevent cross-contamination between the two portions used for fingerprints from two individuals, case 200a may be closed at the top by hinged case cover 500 with left and right side portions 502 and 504 that can be separately lifted from and closed over the open top of case 200a, to which the fingerprint-impressionable material is exposed. The hinging can be accomplished in a desired manner. In one embodiment, cover 500 is plastic, and hinging is accomplished by living hinge area 506. Area 506 can be permanently affixed to or removably received on the top of case 200a. Portions 502 and 504 would preferably include features that allowed it to be tightly fit over the top of the case, such as using snap features on the cover and the case, as described above. The case and/or the cover would preferably be permanently marked with an identification of the person who left the impression, such as “mother” and “father.”

FIG. 6 details an embodiment of a container that can hold two of the devices, or one device and another identifier, in separate compartments. Container 600 defines storage compartments 602 and 604 that are separated by internal wall 608. Hinged cover 606 provides access. The drawing shows identifiers 603 and 605 being placed into the compartments. As an example, one could be a maternal identifier and one paternal. As an alternative, container 600 could hold one identifier device and a “boil and bite” bite impression wafer such as a “Toothprints” wafer, which could be used as a second child identifier when the child whose saliva and cells were captured on the device when the child was born, was old enough to provide a bite impression. As the Toothprints wafer can also capture saliva and cells, this is also a means to maintain a sample that is likely several years fresher than the newborn sample.

Another option with the invention is to use a thermoplastic material for fingerprint impression that was soft and sticky enough to retain some skin cells. The DNA from the cells could then be used as another parent or adult identifier means. If a construction is desired such that this stickier material was not used on the end of the device that is swabbed in the infant's mouth, two different materials could be accomplished in a unitary device by butt joining or insert molding, for example. Another way to accomplish skin cell retention would be to include a strip of double-sided sticky tape that is pressed against the skin. The tape could be preassembled onto the top part of the case, which is then protected when the case is closed.

Yet another option is to include a spreadable or sprayable substance that can be applied after sample collection to stabilize the DNA, so that it has a longer useful storage life. Such substances are known in the art. The substance would be provided separately, for example in a pre-loaded packaged swab, and applied to the surface post sample collection. Another option would be to provide a substance in a spray applicator, which may be advantageous as it allows application without disturbing the underlying sample.

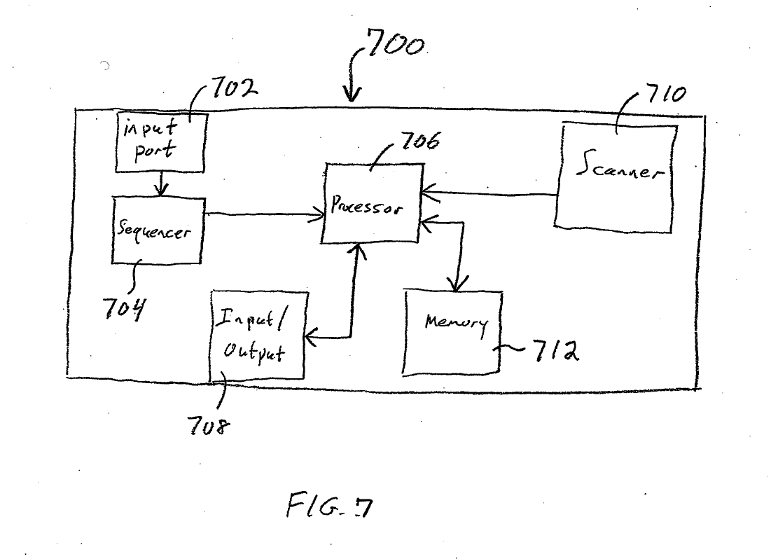

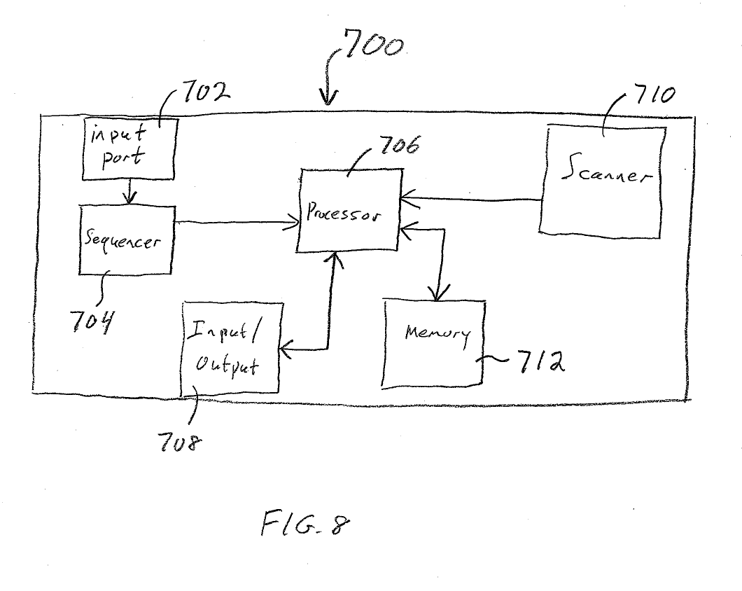

An alternative embodiment of the inventive device 700, FIG. 7, takes a digital scan of the fingerprint as well as a digital conversion of the DNA sample, and stores the information representative of the samples from two people on the device in digital memory form. This digital copy of each component could be accessed as many times as needed without the need to further sample or repeat the sample collection. The fingerprint scan could be accomplished with known biometric scanner 710 of the type that is used for security on some laptop computers. The fingerprint scanner only needs to be a single optical line that the user passes a finger over, effectively capturing the entire print. The DNA sample would require DNA sequencing using known or future-developed technology. Sequencing should be done within the device, but could be done separately with the results stored in the digital memory of this embodiment of the device. Sequencing within device 700 can be accomplished by inputting the saliva and cell samples through input port 702 (either by swabbing this portion of device 700 as described above, or by obtaining a separate swab (e.g., with a cotton swab), and transferring the material into port 702) to provide them to DNA sequencing device 704. Alternatively, if a separate DNA sequencer is used, the digital information representing the sequence can be input through I/O 708. Processor 706 manages information flow and device operation, and communicated with digital memory device 712 (the portable (battery) power source is not shown in the drawing for the sake of clarity). Both the fingerprint and DNA would be accessible by extracting the data from the memory/embedded software package; physical sample degradation is thus not an issue.

In this or another embodiment in which the biometric information is stored in digital memory as opposed to physical samples, the scent of the saliva could be captured using existing or future-developed technologies. An appropriate existing means to digitally capture a scent is to use the “digital nose” technology that is used frequently during food processing and fragrance manufacturing; this could be used in addition to or in place of sequencer 704. The smell of the saliva could then be determined, and its representation stored digitally in memory 712. The scent could then be replicated as necessary if a sample is needed for scent dog tracking—this process is similar to how custom paint is mixed. A base saliva scent is used, and various components are added to the mix to result in the final scent that replicates the digitally stored scent.

Provided devices serve as an accurate, safe, reliable, inexpensive means to provide biometric identification of an infant from birth. Additionally, provided devices may be used for identifying children and/or child/parent matching through at least the first three years of life. Use of a device does not require difficult or cumbersome sample collection procedures such as requiring ink products, collection of blood, or pulling of hair follicles. Nor does use require storage of additional supplies beyond a biometric identification device itself for sample collection. Thus, additionally provided are methods of use of biometric identification devices described herein.

In one embodiment, provided is a method of collecting samples for generating a biometric parent and infant identification and matching device. A method comprises use of a biometric device described herein for collection of an oral swab comprising epithelial cells and saliva from an infant, and collection of a fingerprint impression from a parent. Following obtaining samples, a device is stored in a sealed storage container. Collection and subsequent storage of both samples provides a definitive link of a parent and child, thereby providing a biometric parent and infant identification device. A resulting device and samples can then be used for future identification methods if ever necessary.

Samples from a parent (e.g., a mother) and infant may be taken in any order. In certain embodiments wherein sample is first collected, the device portion containing collected sample is preferably contained in order to retain sample integrity and to prevent contamination, loss or confusion of a first collected sample. Such first containment is preferably suitable to retention of the sample according to whatever applicable sample type is obtained. For example, when a first sample comprises a fingerprint, the portion of a device containing the fingerprint impression sample may be preferably contained within a cover that prevents disruption of the impression. Similarly, when a first sample comprises a scent or DNA sample, the portion of a device containing the sample may be preferably contained within a container that seals the scent or DNA to prevent contamination or loss.

In a preferred method, a parent's fingerprint impression is obtained at or soon after admission to a healthcare facility in anticipation of birth. This is accomplished in the preferred embodiment by removing top cover 300 and having the mother press a finger on end 102. The top cover is then replaced; the two covers protect the impression from degradation through later handling. Following birth, a sample is collected from an infant on a device. In a preferred method, an infant sample is collected within an hour of birth. The device is held by the snapped-together case, and free end 104 is swabbed in the mouth. The entire device is then sealed in a bag or other overall container, such as shown in FIGS. 4 and 6. Often a parent sample is a mother's sample, however, a parent sample may include a sample from a father or guardian.

In certain situations it may be impossible or impractical to obtain a parent sample first. Thus, in other embodiments, an infant sample is collected first (e.g., after or within an hour of birth), and a parent sample is obtained subsequently. Such order of sample collection may be preferable in certain situations such as, but not limited to, when an infant's parent is not a biological parent (e.g., a child born from egg or sperm donations, an adopted child), and an infant does not share genetic information with one or both parents. Such a situation makes it impossible to extrapolate DNA from parents for matching and/or positive identification of an infant, whatever the circumstance (e.g., unidentified, deceased). A parent or guardian sample may be obtained with a device upon or as close as possible to positive confirmation of a parent/child match.

To optimize use, efficacy, and integrity of provided devices and collected samples, personnel collecting samples should be trained in proper identification sample collection techniques. For example, capture of a salivary DNA and scent sample can be obtained in a simple three-second “saliva swipe” method. Additionally, capture of an effective fingerprint impression can be obtained in a simple ten-second fingerprint recorded on a device. When carried out properly, a completed device and collected samples provide a parent's fingerprint linked to an infant's DNA and scent sample on the dual end of an identifier device in a matter of two simple sample collection techniques. These simple collection procedures in conjunction with a device provide a tool to help identify and track an infant, as well as to link a parent-child match.

Following sample collection a device is optionally further provided with suitable identification means (e.g., labeled with information such as name, date of birth, etc.), a device containing samples should be stored in a storage container (e.g., a small moisture proof container) having closure means that includes a seal to prevent contamination. Additionally, a storage container may be sealed with an optional security seal (e.g., to discourage inadvertent opening of the storage container, to detect tampering).

The resulting stored biometric identification device containing sample(s) is provided immediately to a parent for safekeeping, in hopes that it will never need to be used. Thus, no further storage or systematic filing is required on the part of a healthcare facility.

Optionally a facility, or an outsourced vendor may be employed to undertake systematic filing and/or storage of a stored biometric identification device containing sample(s) on behalf of a parent or guardian.

In the event of infant confusion, or worst yet child abduction, an uncontaminated device for identification, DNA analysis, fingerprint analysis and an uncontaminated scent article for scent dog tracking can be provided to authorities. A method of identification of a child (e.g., an unidentified child, a deceased child, samples of child DNA) may be carried out by using a sample (e.g., a DNA sample, a scent sample) from a child and comparing the sample to a retained sample from a biometric identification device as provided herein. A positive match of the samples to each other confirms positive identification of the child.

Additionally, a method of identification of a parent-child match may be carried out by using samples from a putative parent and child and comparing the samples to a retained samples from a biometric identification device as provided herein. A positive match of the infant and putative parent samples to the samples from the biometric tool confirms a positive identification of the parent-child match.

Provided devices and methods give parents and healthcare facilities an extra measure of security for newborns; and provide authorities with preferred samples for positive child and parent identification and matching (e.g., uncontaminated scent sample). The devices and methods described herein thus provide parents the peace of mind knowing that they now have a means of establishing that a newborn is the child that they will raise as their own child (e.g., lessens the fear of a ‘switched at birth’ scenario), and also provides healthcare facilities with the ability to provide an extra measure of safety for the infants delivered in their hospital. Thus, collection of infant and parent samples using provided biometric identification devices makes this an invaluable tool for implementation in formal policies and procedures for proper infant identification programs, as well as for use by forensic scientists in identification programs.

As described herein, a biometric identification device and collected samples can be used for at least the first three years of a child's life. This timing coincides with a typical timing for a child's first dental visit. It is envisioned that at such time a dental impression and saliva sample may optionally be taken to update a child's sample and records.

Optionally, provided devices and methods may be coupled with a separate dental impression (e.g., using a Toothprint® dental impression device) of a parent (e.g., the mother). Similar to a fingerprint impression, a dental impression may be taken prior to or after delivery (e.g., at the time of admission, at the time of discharge from a healthcare facility). Such a combination confers the strongest policy and procedures for infant-parent identification that a healthcare facility could incorporate.

Any patent and scientific literature referred to herein establishes knowledge available to those of skill in the art. The issued patents, applications, and references cited herein are hereby incorporated by reference in their entirety to the same extent as if each was specifically and individually indicated to be incorporated by reference.

While the foregoing invention has been described in some detail for purposes of clarity and understanding, particular embodiments are to be considered as illustrative and not restrictive. It will be appreciated by one skilled in the art from a reading of this disclosure that certain changes in form or detail may be made without departing from the scope of the invention and are within the scope of the following claims. For example, features shown in some drawings and not others may be combined in different manners in accordance with the invention.

What is claimed is:

1. A two-person biometric identification device, comprising:
a first portion adapted for collection of an oral swab comprising epithelial cells and saliva;
a second portion adapted for collection of a biometric sample from another person; and
a third portion connecting the first portion and second portion.

2. The device of claim 1 wherein the device comprises an integral non-scented, non-bioreactive, bioinert material and wherein the oral swab is collected from an infant and the biometric sample comprises a fingerprint collected from an infant's parent.

3. The device of claim 2 wherein the fingerprint is collected from the infant's birth mother.

4. The device of claim 1 wherein the first portion comprises ridges for facilitating collection of cells and saliva.

5. The device of claim 1 wherein the first portion comprises one or more holes or openings in the device for facilitating collection of a sample.

6. The device of claim 1 wherein at least the second portion comprises a thermoplastic material.

7. The device of claim 1, further comprising a container.

8. The device of claim 7 wherein the container comprises a removable cover for holding at least the second portion and positioning the second portion for collection of a fingerprint.

9. The device of claim 8 wherein the removable cover comprises separate bottom and top cover portions for protecting the second portion sample collection area.

10. The device of claim 9 further comprising a sealable storage container.

11. The device of claim 10 wherein the sealable storage container comprises a sealable plastic bag.

12. The device of claim 7 wherein the container comprises a case which holds the device to retain integrity of collected sample.

13. The device of claim 1 further comprising one or more markings on the device to assist in sample collection or sample storage.

14. The device of claim 1 wherein the device is formed from a thermoplastic material.

15. The device of claim 14 wherein the first portion further comprises an absorbent material to assist in saliva sample collection.

16. The device of claim 1 further comprising a digital memory device that stores information representative of the oral swab and the biometric sample.

17. The device of claim 16 wherein the stored information comprises one or more of a DNA sequence, a representation of the scent of the saliva, and a digital scan of a fingerprint.

18. A method of collecting samples for generating a biometric parent and infant identification and matching device comprising using a device according to claim 1 for collection of an oral swab comprising epithelial cells and saliva from an infant and collection of at least a fingerprint impression from a parent, and storage of the device in a sealed storage container; wherein collection and storage of both samples links the parent and child, thereby providing a biometric parent and infant identification device.

19. The method of claim 18 wherein the parent sample is collected from a mother at admission to a healthcare facility in advance of delivery of an infant, and the infant sample is collected from the newborn infant within an hour of delivery.

20. The method of claim 18 wherein the parent sample is collected from a guardian or non-biological parent and the infant sample is collected as soon as the guardian or non-biological parent pair is confirmed.

21. A method of identifying an unidentified child comprising obtaining a sample from a child and comparing the sample to a retained sample from a biometric identification device of claim 1, wherein a positive match of the infant sample to the sample from the biometric identification device confirms identification of the child.

22. A method of identifying a parent-child match comprising obtaining a sample from a child and a potential parent, and comparing the samples to retained samples of an infant and parent from a biometric identification device of claim 1, wherein a positive match of the infant and potential parent samples to the samples from the biometric identification device confirms a parent-child match.
